(19) United States
(12) Patent Application Publication
(10) Pub. No.: US 2021/0259289 A1
(43) Pub. Date: Aug. 26, 2021

(54) PRODUCTION PROCESS OF NIXTAMALIZED MAIZE FLOUR, NIXTAMALIZING THE MAIZE FRACTIONS TOGETHER WITHOUT PRODUCING NEJAYOTE

(71) Applicant: CARLOS SANTAMARIA PEREZ, Los Mochis (MX)

(72) Inventor: CARLOS SANTAMARIA PEREZ, Los Mochis (MX)

(21) Appl. No.: 17/179,759

(22) Filed: Feb. 19, 2021

(30) Foreign Application Priority Data
Feb. 20, 2020 (MX) MX/A/2020/001968

(51) Int. Cl. A23L 7/10; A23P 30/20; A23B 9/08; A23B 9/10; B02B 1/02; B02B 1/04; B02B 3/00; B02C 23/14; B02C 21/00; B02C 23/38

(52) U.S. Cl. CPC A23L 7/197; A23P 30/20; A23L 7/198; A23B 9/08; A23B 9/10; A23V 2002/00; B02B 1/04; B02B 3/00; B02C 23/14; B02C 21/00; B02C 23/38; B02B 1/02

(57) ABSTRACT

The present invention “Production process of nixtamalized maize flour, nixtamalizing the maize fractions separately without producing nejayote”, considers the integration of the processes: Semi-humid milling of the maize (fractionated degerm), extruding of the maize fractions and milling-instant dehydration of the different nixtamalized and extruded maize fractions, has as novelty the way in which the nixtamalization process is carried out and the objective is to provide a nixtamalized maize flour production system that reduces the residues from the maize grain and completely eliminating nejayote production.

### CROSS-REFERENCE TO RELATED APPLICATIONS

“Not applicable”

### BACKGROUND OF THE INVENTION

The production process of nixtamalized flours generates a liquid waste known as nejayote. It's estimated that a tonne of processed maize requires a water volume of three cubic meters, the production of nejayote requires around 50 million cubic meters (Scheel, 2016). If nejayote is left untreated, it can generate environmental pollution due to its high pH and high concentrations of organic matter and calcium hydroxide. Various processes of nixtamalized flour production that reduce or eliminate the production of nejayote are known, these include different configurations of operations which include extrusion, fragmentation of the parts of maize grain.

In that sense, different devices can be cited:

I.—The state of the technique of the patent MXPA05006459 describes the cooking of the pre-milled grain particles in presence of food grade lime and/or hydrochloric acid and water, using the equipment, known as extruder, in which heat can be added using electrical resistances and/or water vapor and/or combustion gases if needed. In this manner, doughs are produced and/or semolina and/or precooked flours that possess chemical and nutritional characteristics similar to their traditionally processed counterparts. The problem of passing the whole grain through the extruder is that it produces flours that, when used in tortillas, yield rigid products. Unlike the present invention where the fibers of the grain are milled and are later added to the extruder producing soft products. In addition to the beforementioned, the grain is hydrated and polished before the fractions pass through the extruder, this way the properties of the flour improve and clogging in the extruder is avoided. In addition, the present invention uses the process of milling-instant dehydration, these operations allow control over the cooking and in the flour-dough-tortilla efficiency.
II.—The state of the technique of the patent MX 283057 B describes a process and device for the continuous production of ground nixtamalized and whole maize flour for grain-based foods, that includes pre-condition clean maize, mill the moistened maize to produce fractions of fine and coarse milling, sift the fine milling and vacuum both fractions, one fraction of light maize bran as animal feed, remill the coarse milling for the extraction of additional maize bran and mix the sifted fine milling with food grade lime to yield a milling with food grade lime, precook with low humidity a current of maize particles with food grade lime against a current of saturated vapor to obtain a partial degree of pre-gelatinization of starch and denaturation of protein, ventilate and separate the heated maize particles with humidity, conditionate the segregated fine milling to soften and inflate the fractions of endosperm, germ and bran, cool the fine milling dried with clean air; mill the agglomerated particles, classify and separate the fine milling yielded by the coarse milling while the last fraction is remilled and sifted to yield a pre-gelatinized flour for tortillas and maize-based foods. The aforementioned patent yields a by-product utilized for animal feed, in the present invention most of the grain is used which represents a technical advantage. The aforementioned patent does not use extrusion or milling-instant dehydration, these operations allow control over the cooking and in the flour-dough-tortilla efficiency.
III.—The state of the technique of the patent application MXPA/a/2005/002025 describes an improved process for obtaining of dough or maize flour, which utilizes a modified system of extrusion that features two extrusion tubes, where the first extruder nixtamalized the maize and the second accelerates the cooling of the mixture, which will prevent the flocculation of the starch. The problem of passing the whole grain through a system of extruders is that it produces flours that, when used in the preparation of tortillas, yield rigid products. Unlike the present invention where the grain fibers are milled and are then added to the extruder producing soft products. In addition to the beforementioned, the grain is hydrated and polished before the fractions pass through the extruder, this way the properties of the flour improve and clogging in the extruder is avoided.
IV.—The state of the technique of the patent MX 290668 B describes a process of nixtamalization where the fractions of maize endosperms, sub-fractions or combinations thereof, are nixtamalized individually to yield food products. When nixtamalizing the fractions and using a relation of four to six parts of food grade lime solution to one part of endosperm fraction a big amount of alkaline solution which will have to be treated is being produced. The present invention does not produce basic effluents; therefore, it is more friendly with the environment than the aforementioned patent. In addition, the present invention uses the process of extrusion and milling-instant dehydration, these operations allow control over the cooking and in the flour-dough-tortilla efficiency.
V.—The state of the technique of the patent MX 301668 B describes a process for the production of a flour dough. It utilizes a series of steps of processing that include dry mixing, hydrating, and working the dough or paste in an extruder with a single screw configuration. When mixing the maize grain fractions, adding a gelling agent, and then hydrating them to later on pass them through an extruder as a past, it can generate blockages in the extruder increasing the time of the process. Unlike the aforementioned patent, the grain fibers are milled before passing through the extruder avoiding clogging in the equipment. In addition to the beforementioned, the grain is hydrated and polished before the fractions pass through the extruder, this way the properties of the flour improve and clogging in the extruder is avoided.
VI.—The state of the technique of the patent MX 307096B describes a process and device for the continuous production of whole nixtamalized maize flours, it includes a pre-cook of the whole clean maize with a food grade lime solution to effect a partial hydrolysis of the pericarp and bran with reduced loss of soluble corn in nejayote wastewater. The humidity content is then stabilized, followed then by milling and drying the preconditioned maize for an additional gelatinization of the endosperm in the whole milled grain, later ventilate and separate the dried milled fractions. The aforementioned patent washes cooked maize seeds to eliminate soluble solids and food grade lime excess; therefore, this process yields basic effluents. The proposed invention does not produce basic effluents; therefore, it is more friendly with the environment. In addition, the present invention uses the process of extrusion and milling-instant dehydration, these operations allow control over the cooking and in the flour-dough-tortilla efficiency.
VII.—The state of the technique of the patent application U.S. Pat. No. 4,594,260A describes a selective process of nixtamalization that consists in separating the pericarp from the grain to form a fraction of pericarp and a fraction of endosperm-germ, only subjecting the pericarp fraction to the nixtamalization, heating in an alkaline solution and then mixing the fraction of nixtamalized pericarp with the fraction of untreated endosperm-germ. In the aforementioned patent application, the nixtamalized pericarp is washed by means of a plurality of washing stages, which yields alkaline effluents from the process, unlike the proposed invention which does not yield effluents by washing; therefore, it is less polluting. In addition, the present invention uses the process of extrusion and milling-instant dehydration, these operations allow control over the cooking and in the flour-dough-tortilla efficiency.
VIII.—The state of the technique of the patent MX285780B refers to a process for the production of fresh dough, nixtamalized flour and derived products, which utilizes a series of processing stages that include milling, mixing, hydrating, cooking and continuous cooling to prevent gelatinization. The aforementioned patent includes a mixture with the following fractions of pericarp between approximately 3% to approximately 7% in weight of the maize based mixture and the germ fraction between approximately 1% to approximately 5% in weight of the maize based mixture and it includes a fraction of endosperm between approximately 90% to approximately 93% in weight of the maize based mixture. The difference between the aforementioned patent and the present invention consists in that, with the aforementioned fractions, part of the maize grain is wasted because a maize graine consists between 5% to 6% of pericarp in weight, while the germ is equivalent from 9% to 11% of the weight and the endosperm around 83% of the weight. The proposed invention reduces the residue of the maize grain to a minimum. The aforementioned invention does not use extrusion or milling-instant dehydration, these operations allow control over the cooking and in the flour-dough-tortilla efficiency.
IX.—The state of the technique of the article “Tortillas del maiz azul (Zea mays L.) preparadas por un proceso de nixtamalización fraccionado: usando la metodologia de la superficie de respuesta”, in this work the pericarp, peduncle, and germ were separated from the endosperm in a pneumatic separator. Afterwards, both fractions were nixtamalized. The fraction of pericarp, peduncle, and germ were nixtamalized with an alkaline solution of boiling water (0.29 at 1.71% of calcium hydroxide) in relation fraction of pericarp, peduncle, and germ: alkaline solution 1:1. Afterwards, the endosperm was cooked in a period of 9.2 to 51.2 minutes. Preceedingly, the nixtamalized fractions were dried at 60° C. for five hours. Finally, the dry fractions were milled. In the aforementioned article, a residue of an alkaline solution is formed once the nixtamalization process of the fractions of pericarp, peduncle, and germ is finalized, unlike the present invention which does not yield any residue or alkaline effluent. In addition to the above, another advantage of the proposed invention is that the cooking and nixtamalization of the endosperm is done by an extruder; therefore, there's no generation of a hot water current that later needs to be treated before being taken out of the process. The aforementioned invention does not use extrusion or milling-instant dehydration, these operations allow control over the cooking and in the flour-dough-tortilla efficiency.
X.—The state of the technique of the article “Desarrollo de una harina preparada con base en maiz nixtamalizado por extrusion”, in this article they developed a mixture of nixtamalized maize flour with flour from various legumes that were treated through extrusion, for use in the elaboration of cereal based products. The moistening of the maize grain was carried out in a mixer gradually adding water with calcium hydroxide at 0.7% with a sprinkler letting it rest for 24 hours under refrigeration. Afterwards, the nixtamalization took place during the extrusion of this grain. When the whole grain is passed directly through the extruder rigid flours are yielded, unlike the present invention where the fiber is milled before passing through the extruder, producing soft products. In addition, the present invention uses the process of milling and instant dehydration, these operations allow control over the cooking and in the flour-dough-tortilla efficiency.
XI.—The state of the technique of the thesis “Nixtamalización fraccionada de maiz y su influencia en las propiedades fisicoquimicas de harinas”. In this thesis an alternative process was designed for the elaboration of nixtamalized maize flours, through the nixtamalization hydration of the previously fractioned grain in conditions of no saturation of Ca(OH)¬2 and reduced volumes of water, for the purpose of obtaining flours with characteristics similar to traditional maize flours. The difference between the aforementioned thesis and the present invention lies in the nixtamalization method, since an extruder is used in the proposed invention being more efficient in the process of modification of the starches of the endosperms in less time and with greater energetic efficiency, always looking to control of the gelatinization temperature. In addition to the aforementioned, the present invention uses the process of milling and instant dehydration, these operations allow control over the cooking and in the flour-dough-tortilla efficiency.
XII.—The state of the technique of the thesis “Efecto del proceso de nixtamalización sobre el contenido de carotenoides en diferentes hibridos de maiz”, in this work the maize was pulverized in a mill and subsequently mixed with food grade calcium hydroxide. Afterwards, distilled water was added to reach 28% percent humidity with a sprinkler. To later be stored at 4° C. for 12 hours. The next step was processing the material in a simple screw extruder with a screw of 19 mm of diameter and 38 cm of length at a feeding speed of 70 g/min. The resulting extrudates were cooled and dried at room temperature and in darkness for 16 hours to then be pulverized in a mill of simple screws to later be milled in another mill to yield particles inferior to 0.5 mm. The aforementioned work completely mills the maize grain to the be mixed with calcium hydroxide, which can lead to an incorrect nixtamalization being that the different parts of the grain (pericarp, endosperm, and germ) require different nixtamalization conditions to yield the suitable properties for flour. In the proposed invention the parts of the grain are given treatment to obtain a better consistency in the flours, a double screw extruder is used with a configuration that allows to control the cooking of the endosperms and the milling-instant dehydration is used to control the flour-dough-tortilla efficiency.
XIII The state of the technique of the article “Efecto de la xilanasa en el maiz nixtamalizado extruido harina y tortilla: caracteristicas reológicas y fisicoquimicas”. In this article the following process is described: White maize was cleaned in a vibrating cleaner, consequently the maize was milled in a mill with a mesh of 0.8 mm, later on the milled maize was mixed with 0.3% (p/p) of food grade lime in a mixer for five minutes. The xylanase that was previously deluded in deionized water, was immediately added to the mix to reach a final humidity content of 30%. Then the mixture was stored for 12 hours at 5° C. Before the extrusion, each mixture was tempered to 25° C. for four hours. The extrusion was carried out in a single screw extruder, with a screw diameter of 19 mm and a length-diameter relation of 25:1, a relation of nominal compression of 2:1, a die opening of 3 mm and four zones of heating and cooling. The velocity of the screw was 112 rpm, the temperature of the stages was 60, 70, 80 and 90° C. The extrudate was dried in a tunnel drier at 65° C. for an hour, then it was milled in a mill with a 0.8 mm mesh. Unlike the aforementioned article, the proposed invention does not use enzymes to give better properties to the flours and tortillas, by utilizing enzymes the process increases its operation costs. The difference lies in that the present invention separates the parts of the grain. In addition to the above, fibers are milled before they are passed through the extruder, in this manner the starches are modified and yield soft flours. The milling-instant dehydration is also utilized to allow for a better control over the flour-dough-tortilla efficiency.
XIV. The state of the technique of the thesis “Nixtamalización por extrusion de las fracciones del grano de maiz para la obtención de harinas instantaneas” which describes the following process: the grain was subjected to a soaking process for 17 minutes at a water temperature of 40° C., later on the water was eliminated through a runoff of 10 minutes, then they pass through a continuous dehuller at a velocity of 800 rpm. Consequently, the fractions were subjected to a separation process with a pneumatic equipment where the endosperm is separated and on the other side point germ and pericarp. Later, they were subjected to a vacuum oven at 60° C. for 12 hours. Then they were moved to a milling process in a hammer with 0.25 mm circular hole meshes. Consequently, a simple screw extruder was used, the velocity of the extruder was 50 rpm, which had three stages. The specifications of the equipment were an endless screw of 95° C., 6 cm of diameter and a compression relation of 1:1. The output of the extrudate was regulated by a circular matrix of 1.905 cm of diameter where the material was cut to pieces of 2-3 cm of length to facilitate the drying process. Then it was dried in trays at a temperature of 60° C. for 12 hours. After the drying of the sample, they were subjected to a fine milling with a micro pulverizer with a 0.25 mm mesh. If the process of the aforementioned thesis utilizes percentages greater than 15% of point germ and pericarp in the extruding stage, the tortillas do not yield good properties. This problem does not present itself in the proposed invention, since the fibers are milled before they are passed through the extruder and it also utilizes milling-instant dehydration to allow control in the flour-dough-tortilla efficiency.
XV.—The state of the technique of the patent application MX/a/2020/001704 which is composed of the of the following stages: Clean the grains, hydrate the grains, polish, dry fibers fractions, sift fibers fractions, mill, hydrate endosperms, degerm, mill with BCH roller mill and sift, nixtamalize, nixtamalize endosperms of uniform size, extrude, mix, mill and instantly dehydrate, cool, add milled germ and pericarp, sift, remill, and store. The aforementioned patent application considers two stages of polish-degerm, first of the grains and then of the endosperms, unlike the present invention where only one stage of polish-degerm is utilized and it's of the grain. In addition, in the present invention the pericarp and germ are milled and can be nixtamalized before the extrude stage together with the flours or sent to mix before the final sifting of the process. Additionally, the aforementioned patent application utilizes two separate nixtamalization processes for the different grain fractions, while the present invention utilizes only a single nixtamalization process for all the grain fractions, therefor the aforementioned application and the present invention are different.
Bibliography: Scheel, C. 2016. Beyond sustainability. Transforming industrial zero-valued residues into increasing economic returns. Journal of Cleaner Production, 131, 376-386.

### BRIEF SUMMARY OF THE INVENTION

The production process of nixtamalized maize flour, nixtamalizing the maize fractions together without producing nejayote, is carried out through the following stages: clean the grains (1), hydrate the grains (2), polish (3), dry fibers fractions (4), sift fibers fractions (5), mill pericarp and germ (6), nixtamalize (7), extrude (8), mill and instantly dehydrate (9), cool (10), add milled germ and pericarp (11), sift (12), remill (13), and store (14). This process does not produce nejayote nor alkaline solutions, hydrating only the fractions of endosperm, dark flours, milled pericarp and germ, with a calcium hydroxide solution. The novelty of this invention lies in the way the nixtamalization process takes place, which is the combination of the steps described as: g) nixtamalize, in which all the fractions of the maize grain (endosperms, dark flours, and milled pericarp and germ) are nixtamalized and h) extrude. Being that, in the stage of nixtamalize the endosperms, dark flours and milled pericarps and germ hydration of the starches is achieved in presence of food grade lime and, in the stage of extrude, the transformations of the abovementioned starches is completed, which results in properties such as the texture, aroma and flavor of the doughs and tortillas, similar to traditionally nixtamalized doughs.

### BRIEF DESCRIPTION OF THE SEVERAL VIEWS OF THE DRAWING

FIG. 1 shows the flux diagram of the production process of nixtamalized maize flour, nixtamalizing the maize fractions together without generating nejayote.

### DETAILED DESCRIPTION OF THE INVENTION

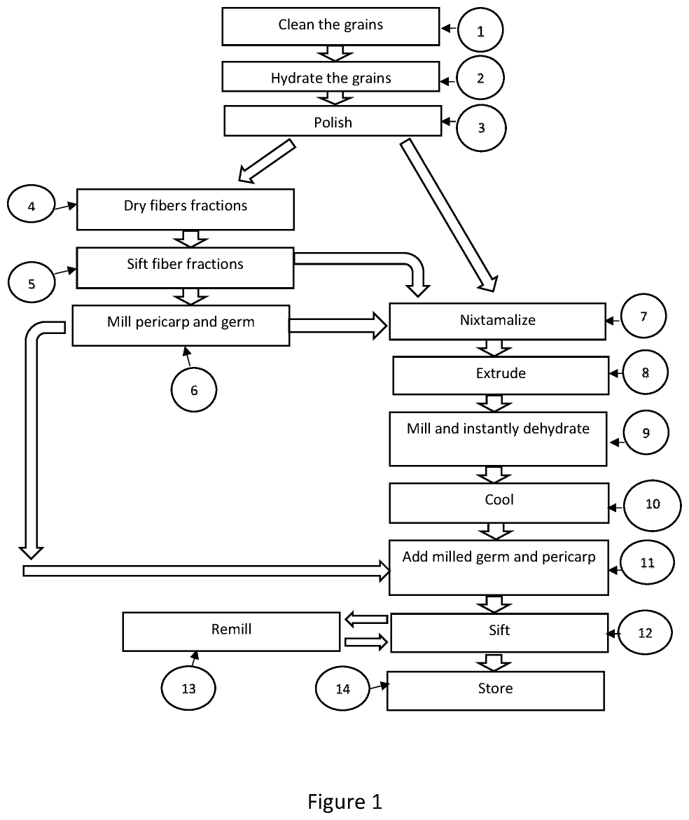

The production process of nixtamalized maize flour, nixtamalizing the maize fractions together without generating nejayote is represented in FIG. 1 and includes the following stages:
a) Clean the grains (1): In this stage, the maize grains pass between magnets to eliminate metals, they're then winnowed to eliminate junk (pieces of leaves, lumps of dirt, and branches), consecutively they're vacuumed to eliminate dust, subsequently they're destoned through density difference, finally a color selection is done to the grains to eliminate the grains that do not comply with the color of the flour to be produced. Afterwards the clean maize grains pass to the hydrate the grains stage.
b) Hydrate the grains (2): In this stage, water is spread over the clean grains by spraying and they're continuously mixed to reach a uniform humidity between 14% and 18%, later they are left to rest for a period of one to ten hours to then move to the polish stage.
c) Polish (3): In this stage of the process, the hydrated grains are polished and rested by a degerminator or grain polishing machine which polishes and separates the grain in two parts, the first one that represents between 20% to 35% of the total grain and is composed by fibers, pericarp, parts of the germ, and dark flours which we will call fiber fractions, the second part are the polished grains and endosperms which we will call endosperms and represent between 65% to 80% of the total of the grain, the granulometry of the endosperms is the following: with a sieve opening of 5.6 mm (US #3.5) a maximum of 12% is retained, with a sieve opening of 4.75 mm (US #4) a minimum of 25% and a maximum of 40% is retained, with a sieve opening of 4 mm (US #5) between 40% to 55% is retained, with a sieve opening of 3.35 mm (US #6) from 2% to 8% is retained, and with a sieve opening of 3.35 mm (US #6) 1% passes through. The degerminator utilizes a rotor and a sifting mesh that can be cylindric or conic, the degerm occurs when the polished and hydrated grains are positioned inside the sifting mesh and the rotor moves the sifting mesh, the grain is separated by the friction made between the grain and the sifting mesh, separating the fibers, pericarp, parts of the germ and dark flours. Afterwards, the endosperms pass to the nixtamalize stage while the fiber fractions pass to the dry fibers fractions stage.
d) Dry fibers fractions (4): The fiber fractions are dried with a stream of hot air at a temperature range of 90° C. to 120° C. Afterwards, the fiber fractions are sifted.
e) Sift fibers fractions (5): the dry fiber fraction is sifted to separate the pericarp and germ from the dark flours, the particles that pass the sieve with a sieve opening range of 0.71 mm (US #25) to 0.85 mm (US #20) are the dark flours fraction, the particles left on top of the sieve with a sieve opening range of 0.71 mm (US #25) to 0.85 mm (US #20) are the pericarp and gem, afterwards the particles left on top of the sieve pass to the mill pericarp and germ stage and the particles that pass through the sieve pass to the nixtamalize stage. From stage a) clean the grains to e) sift fibers fractions is what's catalogued as semi-humid milling of the maize, and in its most important part the grain is moistened to be polished and degerm.
f) Mill pericarp and germ (6): The pericarp and germ are milled in a hammer mill and sieve to obtain a particle size such that 95% of the particles pass through a sieve with a sieve opening of 0.25 mm (US #60). The milled pericarp and germ may pass to the nixtamalize stage or to the add milled germ and pericarp stage.
g) Nixtamalize (7): A solution of calcium hydroxide of 0.1% to 0.15% in weight in relation to the endosperms, dark flours, and milled pericarp and germ (in the case that they are added as well) is hydrated by spraying. The temperature of the calcium hydroxide solution will be at a range of 80° C. to 85° C., afterwards it's left to rest for a period of two to four hours at a temperature of 40° C. to 45° C. In this manner, the mixture of endosperms, dark flours, and, whether or not they were included, milled pericarp and germ will be at a humidity range of 25% to 32% at the final of the nixtamalize stage. Afterwards, the nixtamalized mixture of endosperms, dark flours, and, in the case that they were included, milled pericarp and germ pass to the extrude stage.
h) Extrude (8): The nixtamalized endosperms, dark flours, and milled pericarp and germ are subjected to a double screw extruder in a range of its capacity between 80 to 90%, at an input temperature of the nixtamalized materials of 40° C. to 50° C. and an output material temperature of 60° C. to 70° C. The extruder has three steps with the following temperatures: from 40° C. to 50° C. in the first zone, from 50° C. to 60° C. in the second zone and from 60° C. to 70° C. in the third zone. With an output hole size in the die of 40% to 70% of the equivalent area of the output section of the extruder. The nixtamalized and extruded endosperm, dark flours, and milled pericarp and germ will be called extrudate. The extrudate is cut in small pieces of 0.1 mm to 7 mm, using a four-blade cutter. After the extrudate is cut it's cooled to temperatures lower than 60° C. The cooling can be carried out by means of a pneumatic process, cooling tunnel or ambient ventilation. The humidity of the extrudate is at a range of 25% to 32%. The novelty of this invention lies in the nixtamalization method, which is the combination of the steps described as g) nixtamalize and h) extrude. Being that, in the stages of nixtamalization, altogether, of the endosperms, dark flours, and fibers fraction (milled pericarp and germ), the hydration of the starches in the presence of food grade lime is achieved and in the extrude stage the transformation of the same starches is completed, which results in properties such as the texture, aroma and taste of the doughs and tortillas, similar to those of traditional nixtamalization. After this stage the extrudate is milled and instantly dehydrated.
i) Mill and instantly dehydrate (9): In this stage, the extrudate is milled in a micro pulverizer mill. Afterwards, it's instantly dehydrated with a flux of hot air (Venturi effect), at a temperature range between 200° C. and 400° C., this hot air is transported through a pipe in which the diameter is reduced decreasing its pressure and increasing its velocity (Venturi effect), afterwards the section where the diameter is reduced meets a section where the pipe diameter increases and the air expands causing an instant drying of the milled mixture, this effect is known as venturi. Until the milled and dehydrated extrudate has a humidity between 7% to 11%. Consecutively the milled dehydrated extrudate passes to the cool stage.
j) Cool (10): The cooling is carried out until the milled dehydrated extrudate reaches a temperature between 30° C. and 35° C. by means of pneumatic transport using air at room temperature. Afterwards it passes to the add milled germ and pericarp stage.
k) Add milled germ and pericarp (11): By means of a volumetric dispenser or gravimetric 10% to 15% of the milled germ and pericarp in relation to the milled, dehydrated, and cooled extrudate is added. Afterwards it passes to the sift stage.
l) Sift (12): The mixture of milled, dehydrated, and cooled extrudate and milled pericarp and germ is sifted, the sifting yields two fractions: the fine fraction and the coarse fraction. The fine fraction is nixtamalized maize flour and has the following granulometric properties: with a sieve opening of 0.60 mm (US #30) no particle is retained, with a sieve opening of 0.354 mm (US #45) a maximum of 1% is retained, with a sieve opening of 0.250 mm (US #60) a maximum of 15% is retained, with a sieve opening of 0.177 mm (US #80) a maximum of 80% is retained, and with a sieve opening of 0.150 mm (US #100) a maximum of 6% passes through. The color characteristics of the nixtamalized maize flour are the following: dry color from 30% to 100% reflectance and humid color from 20% to 70% reflectance, while the humidity ranges between 6% to 12%, and pH ranges between 5 to 7. The efficiency of the nixtamalized flour refers to the amount of dough that is obtained by adding water to one kilogram of flour. This efficiency ranges from 1.7 kg to 2.5 kg of dough. The sifted material that does not comply with the granulometric properties will be called coarse fraction and is sent to the remill stage.
m) Remill (13): The coarse factions that are separated by the sieve are sent to be remilled in a micro pulverizer mill and afterwards are sent to the sift stage, the nixtamalized flours that comply with the granulometric properties pass to the store stage.
n) Store (14): The flours that are separated by the sieve are sent to be stored in a hopper or/and packaged in different presentations such as sacks (20 kilograms or 22.7 kilograms), super-sacks (500 kilograms or 1000 kilograms), package (1 or 2 kilograms).

### Use Cases:

Following the production process of nixtamalized maize flour, nixtamalizing the maize fractions together without producing nejayote, in the clean the grains stage, 1000 kg of white maize grains were cleaned to which metals were removed by passing it through two magnets, afterwards it was winnowed and vacuumed to eliminate junk, coarse and fine impurities. Afterwards, the clean maize grains pass to the stage of hydrate the grains. In the hydrate the grains stage water is sprayed, and it was continuously mixed to reach a uniform humidity of 15% to 218%, then they are left to rest for at least one hour, to then pass to the stage of polish. The hydrated and rested grains were polished using a polishing-degerminator machine. Two fractions were obtained: 1. Polished grains and endosperms (endosperm), 2. Mixture of pericarp, germ and dark flours (fibers fraction), the fibers fraction is dried in a stream of hot air (90° C. to 110° C.) at a maximum of 10% humidity, then the sifting takes place to separate the pericarp and the germ form the fark flours, the particles that pass through with a sieve opening of 0.71 mm (US #25) to 0.85 mm (US #20) were the dark flours fractions, the particles left on top of the sieve opening of 0.71 mm (US #25) to 0.85 mm (US #20) were the pericarp and germ. Afterwards the particles that were left on top of the sieve passed to the mill pericarp and germ stage and the particles that passed through the sieve (dark flours) passed to the nixtamalize stage. Then the pericarp and germ were milled in a hammer mill and sifted to obtain a particle size so that 95% passes through a sieve opening of 0.25 mm (US #60). After milling the pericarp and germ, next was the nixtamalize stage where the endosperms, dark flours, and milled pericarp and germ were hydrated by spraying with a calcium hydroxide solution of 0.1% to 0.15% in weight in relation to the endosperms, dark flours, and milled pericarp and germ; the temperature of the solution was ranging between 80° C. and 85° C. Afterwards, it was left to rest for a period of two to four hours at a temperature of 40° C. to 45° C. The nixtamalized materials were subjected to a double screw extruder at a range of its capacity between 80% to 90%, at an input material temperature of 40° C. to 50° C. and an output material temperature of 60° C. to 70° C. The extruder had three steps with the following temperatures: 40° C. to 50° C. in the first zone, 50° C. to 60° C. in the second zone, and 60° C. to 70° C. in the third zone. With an output hole size in the die of 40% to 70% of the equivalent area of the output section of the extruder. The extrudate was then cut into small pieces of 0.1 mm to 7 mm, with a four-blade cutter. After the extrudate was cut, it was cooled to temperatures below 60° C. The cooling took place by pneumatic conveying using room temperature air. The humidity of the extrudate was at a range of 25% to 30%. The extrudate was milled in micro pulverizer mills, and it was then instantly dehydrated with a flow of hot air at a temperature range of 200° C. to 400° C., this hot air was transported through a pipeline in which the diameter was reduced decreasing its pressure and increasing its velocity (Venturi effect). Until the milled and dehydrated extrudate had a humidity ranging between 7% and 11%. Afterwards, the milled and dehydrated extrudate passed to the cool stage, the cooling took place until the milled and dehydrated extrudate reached a temperature between 30° C. and 35° C., by means of a pneumatic conveyor using room temperature air. By means of a volumetric dispenser, 10% to 15% of milled germ and pericarp in relation to the milled, dehydrated, and cooled extrudate were added. Afterwards, the mixture of milled, dehydrated, and cooled extrudate with milled pericarp and germ passed to the sifting process where the flour had the following granulometric characteristics: with a sieve opening of 0.60 mm (US #30) no particles were retained, with a sieve opening of 0.354 mm (US #40) a maximum of 1% was retained, with a sieve opening of 0.250 mm (US #60) a maximum of 15% was retained, with a sieve opening of 0.177 mm (US #80) a maximum of 80% was retained, and with a sieve opening of 0.150 mm (US #100) a maximum of 6% passed through. The flours that did not comply with the specified granulometry were sent to the remill stage, in micro pulverizer mills, and were integrated to the sifting. The color characteristics of the produced flour were the following: dry color of 84% reflectance and humid color of 40% reflectance, while the humidity was at 7% and pH at 6.3. The efficiency of the flour to dough obtained adding water to one kilogram of flour was 2.25 kilograms of dough.

Having sufficiently described my invention, I consider it a novelty and therefore I claim as my exclusive property the content of the following clauses:

1. The process of nixtamalized maize flour production, nixtamalizing the maize fractions together without producing nejayote characterized in that it comprises the following stages:
a) Clean the grains (1): In this stage, the maize grains pass between magnets, they're then winnowed, consecutively they're vacuumed, subsequently they're destoned, finally a color selection is done so that, afterwards, the clean maize grains are passed to the hydrate the grains stage.
b) Hydrate the grains (2): In this stage, water is spread over the clean grains by spraying, they're left to rest for at least an hour, to then pass to the polish stage.
c) Polish (3): In this stage of the process, the hydrated grains are polished and rested by a degerminator or grain polishing machine which polishes and separates the grain in two parts, the first one that is composed by fibers, pericarp, parts of the germ, and dark flours which we will call fiber fractions, the second part are the polished grains and endosperms which we will call endosperms, afterwards the endosperms pass to the nixtamalize stage while the fiber fractions pass to the dry fibers fractions stage.
d) Dry fibers fractions (4): The fiber fractions are dried with a stream of hot air at a temperature range of 90° C. to 120° C. Afterwards, the fiber fractions pass to the sift fiber fractions stage.
e) Sift fibers fractions (5): the dry fiber fraction is sifted to separate the pericarp and germ from the dark flours. The particles that pass through the sieve with a sieve opening of 0.71 mm to 0.85 mm are the dark flours fractions, the particles left on top of the sieve with a sieve opening of 0.71 mm to 0.85 mm are the pericarp and the germ, afterwards the particles left on top of the sieve pass to the mill pericarp and germ stage and the particles that pass through the sieve pass to the nixtamalize stage.
f) Mill pericarp and germ (6): The pericarp and germ are milled in a hammer mill and sifted to obtain a particle size such that 95% of the particles pass through a sieve with a sieve opening of 0.25 mm, afterwards the milled pericarp and germ pass to the add milled germ and pericarp stage.
g) Nixtamalize (7): A solution of calcium hydroxide of 0.1% to 0.15% in weight in relation to the endosperms, dark flours, and milled pericarp and germ (in the case that they are added as well) is hydrated by spraying. The temperature of the calcium hydroxide solution will be at a range of 80° C. to 85° C., afterwards it's left to rest for a period of two to four hours at a temperature of 40° C. to 45° C., the mixture acquires a humidity range between 25% and 32%. Afterwards, the nixtamalized endosperms, dark flours, and, in the case that they were included, milled pericarp and germ pass to the extrude stage.
h) Extrude (8): The nixtamalized endosperms and dark flours, and the nixtamalized milled pericarp and germ (if they were added) are subjected to a double screw extruder in a range of its capacity between 80 to 90%, at an input material temperature of 40° C. to 50° C. and an output material temperature of 60° C. to 70° C., the extruded materials (endosperm, dark flour, and milled pericarp and germ, if included) will be called extrudate. After this stage, the extrudate is milled and dehydrated.
i) Mill and instantly dehydrate (9): In this stage, the extrudate is milled in a micro pulverizer mill. Afterwards, it's instantly dehydrated with a flux of hot air, at a temperature range between 200° C. and 400° C., this hot air is transported through a pipe in which the diameter is reduced decreasing its pressure and increasing its velocity, afterwards the section where the diameter is reduced meets a section where the pipe diameter increases and the air expands causing an instant drying of the milled mixture (venturi effect). Consecutively the milled dehydrated extrudate passes to the cool stage.
j) Cool (10): The cooling is carried out until the milled dehydrated extrudate reaches a temperature between 30° C. and 35° C. by means of pneumatic transport using air at room temperature. Afterwards, milled germ and pericarp is added.
k) Add milled germ and pericarp (11): By means of a volumetric dispenser or gravimetric 10% to 15% of the milled germ and pericarp in relation to the milled, dehydrated, and cooled extrudate is added. Afterwards it passes to the sift stage.
l) Sift (12): The mixture of milled, dehydrated, and cooled extrudate and milled pericarp and germ is sifted, the sifting yields two fractions: the fine fraction and the coarse fraction. The fine fraction is the nixtamalized maize flour and it's sent to the store stage, while the sifted material that does not comply with the granulometric specifications is called coarse fraction and it's sent to the remill stage.
m) Remill (13) The coarse factions that are separated by the sieve are sent to be remilled in a micro pulverizer mill and afterwards are sent to the sift stage, the nixtamalized flours that comply with the granulometric properties pass to the store stage.
n) Store (14): The flours that are separated by the sieve are sent to be stored in a hopper or/and packaged in different presentations.

2. The production process of nixtamalized maize flour, nixtamalizing the maize fractions together without producing nejayote in conformity with claim 1 characterized in that in stage b) Hydrate the grains, in this stage water is spread over the grains to reach a uniform humidity between 14% and 18%, afterwards it's left to rest for a period of time between one and ten hours.

3. The production process of nixtamalized maize flour, nixtamalizing the maize fractions together without producing nejayote in conformity with claim 1 characterized in that in stage c) polish: the hydrated and rested grains can also be polished by a grain polishing machine.

4. The production process of nixtamalized maize flour, nixtamalizing the maize fractions together without producing nejayote in conformity with claim 1 characterized in that in stage c) polish: the fibers fractions that are composed of fibers, pericarp, parts of the germ, and dark flours represent between 20% to 35% of the total of the grain, while the polished grains and endosperms represent from 80% to 65% of the total of the grain.

5. The production process of nixtamalized maize flour, nixtamalizing the maize fractions together without producing nejayote in conformity with claim 1 characterized in that in stage c) polish, the operation of polishing is carried out by means of one of the following equipment: degerminator, grain polishing machine.

6. The production process of nixtamalized maize flour, nixtamalizing the maize fractions together without producing nejayote in conformity with claim 1 characterized in that in stage c) polish, the degerminator may utilize a sifting mesh that is cylindric or conic.

7. The production process of nixtamalized maize flour, nixtamalizing the maize fractions together without producing nejayote in conformity with claim 1 characterized in that in stage f) mill pericarp and germ: if the milled pericarp and germ is not sent to the add milled germ and pericarp stage, it may pass directly to the nixtamalize stage.

8. The production process of nixtamalized maize flour, nixtamalizing the maize fractions together without producing nejayote in conformity with claim 1 characterized in that in stage h) extrude, the extruder has three steps with the following temperatures: from 40° C. to 50° C. in the first zone, from 50° C. to 60° C. in the second zone, and from 60° C. to 70° C. in the third zone, and with an output hole size in the die of 40% to 70% of the equivalent area of the output section of the extruder.

9. The production process of nixtamalized maize flour, nixtamalizing the maize fractions together without producing nejayote in conformity with claim 1 characterized in that in stage h) extrude, the humidity of the extrudate fractions is at a range of 25% to 30%.

10. The production process of nixtamalized maize flour, nixtamalizing the maize fractions together without producing nejayote in conformity with claim 1 characterized in that in stage h) extrude, the extrudate is cut into small pieces of 0.1 mm to 7 mm, using a four-blade cutter.

11. The production process of nixtamalized maize flour, nixtamalizing the maize fractions together without producing nejayote in conformity with claim 1 characterized in that in stage h) extrude, after the extrudate is cut it's cooled to temperatures lower than 60° C.

12. The production process of nixtamalized maize flour, nixtamalizing the maize fractions together without producing nejayote in conformity with claim 1 characterized in that in stage h) extrude, the extruded and cut material may be cooled by means of a pneumatic process, cooling tunnel or ambient ventilation.

13. The production process of nixtamalized maize flour, nixtamalizing the maize fractions together without producing nejayote in conformity with claim 1 characterized in that in stage i) mill and instantly dehydrate, the milled mixture is dehydrated with a flux of warm air at a temperature range between 200° C. and 400° C.

14. The production process of nixtamalized maize flour, nixtamalizing the maize fractions together without producing nejayote in conformity with claim 1 characterized in that in stage i) mill and instantly dehydrate, the milled extrudate is dehydrated with a flux of warm air until reaching a humidity range of 7% to 11%.

15. The production process of nixtamalized maize flour, nixtamalizing the maize fractions together without producing nejayote in conformity with claim 1 characterized in that in stage l) sift, the milled, dehydrated, and cooled mixture of extrudate is sifted, and has the following granulometric properties: with a sieve opening of 0.60 mm no particle is retained, with a sieve opening of 0.354 mm a maximum of 1% is retained, with a sieve opening of 0.250 mm a maximum of 15% is retained, with a sieve opening of 0.177 mm a maximum of 80% is retained, and with a sieve opening of 0.150 mm a maximum of 6% passes through.

16. The production process of nixtamalized maize flour, nixtamalizing the maize fractions together without producing nejayote in conformity with claim 1 characterized in that in stage l) sift, a nixtamalized flour with the following characteristics is produced: dry color from 30% to 100% reflectance and humid color from 20% to 70% reflectance, while the humidity ranges between 6% to 12%, and pH ranges between 5 to 7.

17. The production process of nixtamalized maize flour, nixtamalizing the maize fractions together without producing nejayote in conformity with claim 1 characterized in that in stage l) sift, a flour with an efficiency of 1.7 kg to 2.5 kg of dough is produced.

18. The production process of nixtamalized maize flour, nixtamalizing the maize fractions together without producing nejayote in conformity with claim 1 characterized in that in stage n) store, the flours that are separated by the sieve are sent to be stored in different presentations of sacks of 20 kg or 22.7 kg.

19. The production process of nixtamalized maize flour, nixtamalizing the maize fractions together without producing nejayote in conformity with claim 1 characterized in that in stage n) store, the flours that are separated by the sieve are sent to be stored in different presentations of super-sacks of 500 kg or 1000 kg.

20. The production process of nixtamalized maize flour, nixtamalizing the maize fractions together without producing nejayote in conformity with claim 1 characterized in that in stage n) store, the flours that are separated by the sieve are sent to be stored in different presentations of packages of 1 kg or 2 kg.
